(19) United States
(12) Patent Application Publication
(10) Pub. No.: US 2022/0033288 A1
(43) Pub. Date: Feb. 3, 2022

(54) DEVICE FOR PURIFYING A FLUID, IN PARTICULAR WASTE WATER

(71) Applicant: SAINT-GOBAIN CENTRE DE RECHERCHES ET D'ETUDES EUROPEEN, COURBEVOIE (FR)

(72) Inventors: Stéphane RAFFY, CAVAILLON (FR); Yves Marcel Léon BOUSSANTROUX, MONTFAVET (FR); Corinne SALLES, CAVAILLON (FR); Brice AUBERT, LE THOR (FR)

(21) Appl. No.: 17/297,224

(22) PCT Filed: Dec. 5, 2019
(86) PCT No.: PCT/FR2019/052944

§ 371 Date: May 26, 2021

(30) Foreign Application Priority Data
Dec. 7, 2018 (FR) 1872477

(51) Int. Cl. C02F 1/461; C02F 1/467; C23C 18/12

(52) U.S. Cl. CPC C02F 1/46109; C02F 1/4672; C23C 18/1254; C23C 18/1216; C23C 18/1241; C23C 4/11; C02F 2001/46157; C02F 2001/46161; C02F 2001/46171; C02F 2201/46115; C02F 2305/023; C02F 2001/46142

(57) ABSTRACT

An electrochemical device for purifying a fluid, for example wastewater or sludge, includes an electrochemical filtering membrane, including a metallic support, for example chosen from a screen, a fabric or an open-pore foam, the support being permeable to the fluid, a coating layer of the support including a titanium oxide of general formula TiOx, with x between 1.5 and 1.9.

The invention relates to an electrochemical device, in particular useful for the treatment of fluids and very particularly liquids, in particular the purification of wastewaters comprising organic compounds.

The difficulties in managing effluents and their content of pollutant products and in particular organic pollutants is currently a major challenge for our societies. Until recently, some of these products were discharged into wastewater treatment effluents without being specifically treated. Current legislation is regulating such discharges increasingly severely.

Very particularly, many organic compounds contained in industrial effluents are toxic for the environment. The most common process for treating organic discharges is currently the biological route. However, the microorganisms used are unsuitable in certain cases for biorefractory or toxic compounds such as medicines. Among the alternative physicochemical techniques, electrochemistry is today a very promising pathway for carrying out a pretreatment that precedes for example the biological process or even for carrying out the degradation, ultimately down to carbon dioxide and water, of the organic products. Advantageously, an electrochemical process does not require any addition of oxidant or other chemical compound and therefore proves to be particularly clean.

In order to improve the treatment of effluents loaded with biorefractory pollutants (for example medicines such as antibiotics, anti-inflammatories, or else textile dyes or pharmaceutical products, etc.) not removed by conventional methods, it is possible to use membrane systems which must have two roles: on the one hand enabling the retention of the organic compounds to be treated and, on the other hand, ensuring the electrochemical degradation thereof. The components used in such membrane systems must therefore have a suitable porosity relative to the size of the polluting particles but make it possible to let the treated effluent pass through while slowing it down, thus prolonging the contact of the compounds to be degraded with the membrane, without generating too large a pressure drop. It must also be electroactive, i.e. enable the degradation of the polluting compounds into non-toxic material or into carbon dioxide by electrochemistry.

Therefore, there is currently a need to develop membranes that act as electrodes comprising or consisting of a stable anode and/or cathode material, preferably anode material, making it possible to carry out the at least partial or indeed complete degradation of the molecular backbone of the organic products. However, the simple transfer of electrons at the interface between the membrane and the fluid to be purified does not appear to make it possible, by itself alone, to accomplish the degradation. Specifically, it is necessary to generate powerful oxidizers such as hydroxyl radicals at the surface of the membrane. The choice of the material constituting the membrane used as electrode, in particular as anode, is therefore an essential element of the treatment process. Moreover, the materials that can be envisaged industrially must have a good chemical resistance in acidic and caustic media but also a long service life.

To this end, electrodes were developed in the 1990s for the removal of organic compounds in wastewater by oxidative electrolysis, in particular based on boron-doped diamond (BDD) as indicated in the publication “Electrochemical synthesis on boron-doped-diamond”, Waldvogel et al.; Electrochimica Acta 82 (2012) 434-443). This compound has a remarkable efficiency, since it enables the generation of highly oxidizing species, such as .OH radicals, useful and highly effective for the degradation of organic compounds. BDD also has a high chemical inertia in acid and basic media. It is furthermore an expensive material that is difficult to use over large surface areas and/or the adhesion of which with the substrate is not always optimal.

Furthermore, porous products are known that are based on titanium suboxides, in particular consisting of or comprising materials based on Magnéli phase Ti₄O₇, Ti₅O₉ or else Ti₆O₁₁ and very particularly based on Ti₅O₉. According to a first of its aspects, the present invention proposes to use such a material that does not have the drawbacks of BDD as one of the constituents of the electrode, in particular of the anode. Patent application WO2018/115749A1 describes a porous product entirely based on titanium suboxide TiOₓ and the process for the manufacture thereof.

The article “Electrochemical impedance spectroscopy study of membrane fouling and electrochemical regeneration at a sub-stoichiometric TiO₂ reactive electrochemical membrane” published in the Journal of Membrane Science, 510-523, (2016) describes the use of a membrane consisting of Ti₄O₇ and Ti₆O₁₁ having a porosity of 28.2% with a median pore size of 3.27 μm and also a bimodal pore distribution.

The article “Development and Characterization of Ultrafiltration TiO₂ Magnéli Phase Reactive Electrochemical Membranes” from the publication “Environmental Science and Technology”, 50(3), p. 1428-36 (2016) describes porous products and in particular a porous electrochemical membrane used for ultrafiltration, the porosity of which is of the order of 30% and the median pore diameter is 2.99 micrometers.

All the publications cited above relate to electrodes consisting exclusively of ceramic titanium oxides. Such an electrode may however be difficult to use effectively since the ceramic material which forms it is inevitably brittle.

The efficacy of such an electrode may nevertheless be improved. Specifically, it is known that only a thin thickness of these ceramic electrodes is active for generating ° OH radicals (cf. Mineralization of organic pollutants by anodic oxidation using reactive electrochemical membrane synthesized from carbothermal reduction of TiO₂, C. TRELLU et al., Water Research vol. 131, 310-319).

Within the context of treating contaminated fluids and in particular wastewater such as domestic drainage water, there is a continuous need for efficient and easy-to-use devices and/or membranes that enable an oxidation of elements that are otherwise difficult to remove such as organic compounds, in particular medicines. The object of the present invention aims to provide such a device.

More specifically, the present invention relates, according to a first aspect, to a device for purifying a fluid, in particular wastewater or sludge, comprising a filtering membrane, said membrane comprising:
a metallic support, in particular chosen from a screen, a fabric, an open-pore foam or a honeycomb, said support being permeable to said fluid,
a coating layer of said support comprising or preferably consisting of a titanium oxide of general formula TiOₓ, with x between 1.5 and 1.9.

In the remainder of the present description, for reasons of conciseness, the material TiOₓ, the x value of which varies between 1.5 and 1.9, preferably between 1.6 and 1.9, according to the invention will simply be denoted by “TiOₓ”.

A pore (or open pore or through pore) is understood within the meaning of the invention to mean any cavity in the material that is open to the outside, optionally by interconnection with other cavities of the material, and that enables said material to be passed through by the fluid to be treated. In a borderline case, a pore according to the invention is therefore a hole of a mesh, in particular when the support consists of a fabric or a screen. The term porous is therefore understood within the meaning of the invention to mean a structure provided with through-holes, irrespective of the shape and the size of the holes. A through-hole is understood to mean that said holes allow a connection of fluid between the two main surfaces of said structure.

Given below are some preferred embodiments of the invention, but which should not be considered as limiting the scope of the present invention:
The support comprises or consists of a metal chosen from titanium, stainless steel, preferably titanium.
The support has a porosity of between 10% and 90%, in particular between 20% and 80%.
The support has a median pore diameter, by volume, of between 10 micrometers and 10 millimeters.
The support has a median pore diameter of less than 50 micrometers.
The support has a median pore diameter of greater than 70 micrometers, preferably greater than 100 micrometers.
The support is a screen.
The support is a fabric of assembled metal wires.
The support is a foam, preferably the overall open porosity of which is between 20% and 90%, and preferably the median pore diameter of which is between 2 micrometers and 10 millimeters.
The support is in the form of a plate or a tube.
The material constituting the coating layer comprises more than 90% by weight, in total, of Magnéli phases selected from Ti₄O₇, Ti₅O₉, Ti₆O₁₁ or from a mixture of at least two of these phases.
The device further comprises means for introducing the fluid to be purified, means for circulating the fluid, for the possible pressurization thereof, means for powering the support and means for recovering the purified fluid.

The invention also relates to the membrane as described above and comprising:
a metallic support, in particular chosen from a screen, a fabric, an open-pore foam or a honeycomb, said support being permeable to said fluid,
a coating layer of said support comprising or preferably consisting of a titanium oxide of general formula TiOₓ, with x between 1.5 and 1.9.

For the sake of conciseness, the optional features described above of such a membrane are not repeated here but are of course part of the present disclosure and of the present invention.

Lastly, the invention relates to various processes that make it possible to obtain the membrane described above and in particular:

According to a first process for manufacturing a membrane, the support comprises or consists of titanium, and the coating layer is obtained by oxidation by anodization or chemical treatment of the support in order to obtain a layer comprising TiO₂ then reduction of said TiO₂ to give a titanium oxide of general formula TiOx, with x between 1.5 and 1.9.

According to a second process for manufacturing a filtering membrane according to the invention, according to a first step, the metallic substrate is bought into contact with a solution of sol-gel type comprising titanium, for example a solution of a tetravalent titanium alkoxide in an alcoholic or aqueous medium, said solution optionally including an additional source of carbon such as an additional organic compound or carbon black, then a second step of heat treatment of the sol-gel layer in order to obtain a coating layer of TiOx, at a temperature between 500° C. but not exceeding 1430° C. at atmospheric pressure, under an inert or reducing atmosphere.

According to a third process for manufacturing a filtering membrane according to the invention, the deposition of the coating layer on the support is carried out by impregnation starting from an aqueous suspension, or a suspension of another solvent, of a TiOx powder, followed by a heat treatment at a temperature between 500° C. but not exceeding 1430° C. at atmospheric pressure, under an inert or reducing atmosphere.

According to a fourth process for manufacturing a filtering membrane according to the invention, the deposition of the coating layer on the support is carried out by impregnation starting from an aqueous suspension, or a suspension of another solvent, of a mixture of titanium oxide TiO₂ powder, preferentially in anatase form, supplemented by an additional source of carbon such as an additional organic compound or carbon black, the TiOx layer being obtained by reduction of said TiO₂ layer by a subsequent heat treatment at a temperature between 800° C. but not exceeding 1430° C. at atmospheric pressure, under an inert or reducing atmosphere.

According to a fifth process for manufacturing a filtering membrane according to the invention, the deposition of the coating layer on the metallic support is carried out by thermal spraying, in particular plasma spraying, of TiOx particles on said support.

The use as membrane, in the purification device as described above, of the porous metallic support permeable to the fluid to be treated, coated by the layer of titanium suboxide(s), has in particular the advantage of improving the mass transport by maximizing the possible contact area between the electrode and the fluid to be treated for a maximum efficiency of the removal of the organic pollutants passing through the device.

More particularly, such a device has the following advantages:
a large increase in the exchange area between the fluid to be treated and the membrane,
improvement in the effectiveness of the treatment via a facilitation of the mass transport, the fluid to be treated passing through the porous membrane acting as electrode, in particular anode in the electrochemical reaction for degradation of the organic pollutants,
a reduction in the current density actually experienced by the TiOₓ material and therefore the increase in its service life,
a reduced ohmic charge loss owing to the presence of the metallic substrate supporting a suboxide that is itself highly conductive. Such a combination thus ultimately enables a lower electrical consumption of the purification device,
a better homogeneity of the potential throughout the volume of the membrane,
a contact time and a contact area that are very greatly increased between the electrode and the polluting species, owing to the porous nature of the support and optionally of its coating, promoting the efficiency of the conversion,
a very good mechanical strength with in particular a good breaking strength owing to the combination between the metallic support, in particular in the form of a screen or a foam, and the ceramic oxide coating,
an increase in the size of the active zone of the membrane while limiting the potential drop throughout the thickness of the ceramic TiOₓ coating owing to the increase in the overall electrical conductivity of the electrode, itself linked to the use of the metallic support.

The final coating layer corresponds to the generic formulation TiOx, the value of x preferably being between 1.5 and 1.9, preferably between 1.6 and 1.9, and preferably between 1.75 and 1.85 and more particularly essentially consists of a phase of TiₙO₂ₙ₋₁ type, n being an integer greater than or equal to 4 and less than or equal to 9. It consists, in particular for at least 70% by weight, in total, of the Ti₄O₇, Ti₅O₉, Ti₆O₁₁ phases, preferably at least 80% or indeed at least 90%, in total (cumulatively) of the Ti₄O₇, Ti₅O₉, Ti₆O₁₁ phases, in particular at least 90%, in total (cumulatively) of the Ti₄O₇ and Ti₅O₉ phases, in particular at least 90%, in total (cumulatively) of the Ti₅O₉ phase. The coating layer according to the invention very advantageously comprises more than 90% by weight, in total, of titanium suboxide(s) corresponding to the generic formulation Ti₅O₂ₙ₋₁. Preferably, said coating layer comprises in total more than 92%, or indeed more than 94%, or else more than 95% of titanium suboxide(s), in particular the Ti₄O₇, Ti₅O₉, Ti₆O₁₁ phases.

All the data on overall open porosity and median pore size described in the present description, below or equal to 300 micrometers, can be measured by mercury porosimetry. The pore volume is measured at 2000 bar by mercury intrusion using a Micromeritics Autopore IV 9520 series mercury porosimeter, on a sample of 1 cm³. The applicable standard is ISO 15901-1: 2016 part 1. The increase in pressure up to high pressure results in the mercury being “driven” into pores of increasingly small size. The median pore diameter (denoted D50 in the tables) corresponds to a threshold of 50% of the population by volume.

Above a pore size of 300 micrometers, the porosity and median pore size parameters are preferably measured from analysis of images of the surface or of a cross section of the part (in particular screen, fabric, etc.) from optical or microscopy photographs in the following manner:

A series of photographs is taken of the surface of the support or of a cross section. For greater clarity, the photographs may be taken on a polished cross section of the surface of the material. The image is acquired in such a way that it contains at least 100 representative pores in order to determine a representative average of the whole of the sample. The area of each pore is measured. An equivalent pore diameter is determined, corresponding to the diameter of a perfect disk of the same area as that measured for said pore (it being possible for this operation to be optionally carried out using dedicated software, in particular Visilog® sold by Noesis or else imageJ software). A pore diameter by volume size distribution is thus obtained according to a conventional distribution curve and a median pore diameter by volume may also be determined.

When the substrate is a screen and a fabric, the porosity parameters are determined from an image of the surface of the support.

The overall porosity for such supports may also be obtained according to the invention by the Archimedes method if the volume of the part is not easily measurable.

In one embodiment particularly well suited to fluids comprising a few pollutants, the median pore diameter is preferably less than 50 microns, or indeed less than 40 microns. Specifically, it is important to maximize the mass transport, in particular by reducing the size of the pores.

In another embodiment particularly well suited to fluids highly loaded with pollutants, the median pore diameter is preferably greater than 70 microns, or indeed greater than 80 microns, or indeed greater than 100 microns to prevent clogging.

Without departing from the scope of the present invention, the layers may however comprise other phases, in particular silica (SiO₂), or else other elements, essentially present in oxide form, or in the form of a defined compound (for example KTi₈O₁₆ or in solid solution with the titanium suboxide(s), in particular Al, Cr, Zr, Nb, Ta, Li, Fe, alkali metals or alkaline-earth metals of Ca, Sr, Na, K, Ba type. On the basis of the corresponding single oxides, the total summed amount of said elements present is preferably less than 10% by weight of the total mass of the product, for example less than 5%, or less than 4%, or indeed less than 3% by weight of the total mass of the product. The presence of these elements may in particular be desired but it is generally and solely linked to the impurities present in the raw materials used.

According to a preferred embodiment of the invention, the porous products according to the invention consists solely of said titanium suboxides, the other phases only being present in the form of unavoidable impurities.

In particular, said titanium suboxides are preferably mainly TiₙO₂ₙ₋₁ phases in which n is between 4 and 6, limits included, i.e. Ti₄O₇, Ti₅O₉, Ti₆O₁₁ which have the best electronic conductivities, said phases preferably and in total representing more than 80%, or indeed 85% or even 90% of the weight of the products according to the invention. Said titanium suboxides more preferably comprise a mixture of Ti₄O₇ and Ti₅O₉ as main phases.

The term “mainly” is understood to mean that the main diffraction peaks observed on an x-ray diffractogram correspond to these Magnéli phases.

In particular, within the meaning of the present invention, a phase is considered to be a “main” phase if it represents more than 25% of the weight of the product and preferably at least 35%, or indeed at least 45% of the weight of the product.

The respective weight percentages of the various phases constituting the product according to the invention may be determined according to techniques well known in the field, in particular by x-ray diffraction, for example by simple comparison of the intensity ratios between the diffraction peaks of the various phases present or else more accurately by Rietveld analysis, according to techniques well known in the field.

As indicated above, the support of the membrane may adopt various aspects without departing from the scope of the invention: it may in particular be a screen, a fabric or else a foam, without however this list being exhaustive.

According to one embodiment, the support is a screen, for example in the form of expanded metal or else a fabric of assembled metal wires. The mesh of the screen or of the fabric of metal wires may be of any shape (square, rectangle, diamond, etc.). Its characteristic dimensions (length and width) and/or its periodicity are between 100 micrometers and 20 millimeters, in particular between 300 micrometers and 10 mm. Its porosity is then preferably between 10% and 90% and in particular between 20% and 80%. Its median pore diameter is between 100 micrometers and 10 millimeters.

A foam is understood within the meaning of the invention to mean a three-dimensional pore structure having an interconnected porosity. According to one advantageous embodiment, the porosity of a foam according to the invention is between 20% and 90%, more preferably between 20% and 70%, or even between 30% and 60%. According to one advantageous embodiment, the median pore diameter of a foam according to the invention is between 2 micrometers and 10 millimeters, preferably between 20 micrometers and 5 millimeters, or indeed between 70 micrometers and 2 millimeters. According to another possible embodiment, the median pore diameter of a foam according to the invention may be between 2 micrometers and 50 micrometers.

The support and consequently the membrane may be shaped according to any possible configuration, in particular in the form of a plate or a tube.

The support may be in the form of a plate that is porous or perforated with holes or in the form of a porous tube, on the outer and/or inner surface of which the titanium oxide TiOₓ coating is deposited.

The support according to the invention comprises one or more constituents of metallic nature, i.e. of which the electrical conductivity is greater than 10³ Siemens per centimeter.

According to one embodiment, the support comprises a discrete or continuous film of elements in metallic form or in the form of oxides of Ru, Ir, Sn, Nb, Ta and/or Sb. According to another embodiment, this film is located at the surface of the coating layer.

According to one particular embodiment, the device consists of several membranes constituting a set of groups comprising at least an anode and a cathode, preferably the fluid first encounters a cathode. According to one embodiment particularly well suited to membranes comprising plates, each membrane is positioned so that its porosity is offset relative to that of the cathode of the same pair. Preferably, an insulating material is positioned between each electrode of the group. Preferably, each pair is separated by an insulating material or a sufficient spacing.

In the case of anodes consisting of a metallic support in the form of foam coated solely at the surface with TiOx (for example by plasma spraying), then the coating exists on the 2 faces of the foam, in order to double the surface capable of producing oxidizing radicals ° OH.

According to another embodiment, the membrane according to the invention is a porous tube made of Ti coated with TiOₓ; the cathode is
either a metallic rod placed in the axis inside the tube (“inside→outside” mode),
or a metallic tube of larger diameter than the membrane-tube, and also placed axially with respect to the membrane-tube (“outside→inside” mode).

The effluent to be treated is then admitted under pressure into the space between the membrane-tube and the metallic tube or rod. Owing to the pressure, a portion of the effluent passes through the porosity of the membrane-tube, the remainder being recirculated (“tangential” mode), or the effluent passes completely through the porosity of the membrane-tube in the absence of recirculation (“frontal” mode).

In all these embodiments, it is possible to periodically reverse the polarity of the system so that the membrane consisting of metal and TiOx operates periodically as cathode, this being in order to prolong its service life. In these cases, it is possible for the second electrode also to consist of Ti and TiOx or of TiOx alone, in order to generate ° OH radicals continuously.

According to one embodiment, the membrane constitutes the anode of the device according to the invention. The cathode for example consists of a titanium screen.

The support of the membrane is then in particular a metal chosen from the group consisting of stainless steel or preferably titanium. Other metals may also be selected to constitute the support, in particular chosen from steels. The choice of Ti metal or of a metal containing Ti is advantageous due to its good electrical conductivity. A low electrical consumption of the anode is therefore possible. According to the invention, in order to promote the electrochemical degradation of the organic compound, it is necessary to establish a good electrical connection between the support and the electric power source of the device and to thus ensure an effective control of the flow of current passing through the membrane.

A titanium support also has the advantage of good corrosion resistance under conditions where the fluid to be purified is either acidic or basic.

Finally, it has also been found that a very satisfactory degree of adhesion could be obtained between the substrate, in particular made of titanium, and its titanium oxide TiOₓ coating.

Such features ultimately guarantee the good operation, reliability and durability of the purification device equipped with such a membrane.

According to one particular embodiment, the coating layer is in the form of a titanium oxide TiOₓ foam having a thickness between greater than 0.1 and preferably less than 10 centimeters, or indeed less than 2 centimeters. According to such an embodiment, the TiOₓ coating is very porous. The coating advantageously has, according to this embodiment, a through open porosity of 30% to 80% and the size of the pores is advantageously between 300 micrometers and 10 millimeters.

The invention also relates to a process for purifying a fluid, in particular wastewater or sludge, when this fluid comprises organic compounds such as medicines, using the device and the membrane as described above.

The process comprises at least the following steps: a step of introducing said wastewater or sludge into a device as described above, a step of bringing said fluid into contact with said membrane acting as electrode, in particular anode, under conditions for oxidation of said organic compounds, and a step of drawing off the wastewater thus decontaminated.

A membrane comprising such a coating layer may for example be obtained by inserting the support, in particular a screen or fabric into the foam prior to the drying step (before sintering) of the process as described in the publication EP1778600A1. Alternatively, when the foam constituting the coating layer is obtained by replication of a foam made of polymer (polyurethane for example), the support may be inserted into the polymer foam (before or after impregnation by the TiOx slip) before the firing cycle which makes it possible to burn off the polymer foam and to sinter the TiOₓ foam.

The deposition of the coating layer on its support, in particular made of titanium or made of a metal comprising titanium, may be obtained according to various processes, a few examples of which are given below:

According to a first process, it is possible to anodize the titanium substrate in order to obtain a surface layer of TiO₂, which is then reduced to give a TiOₓ layer according to the invention (i.e. with x between 1.5 and 1.9).

More specifically, the process may be carried out under the following conditions:
a metallic part is immersed in a conventional anodizing bath (typically a sulfuric acid bath), then
a potential difference is applied between the part to be anodized and a cathode, typically of the order of 10 to 100 volts,
the anodized part is heat-treated at a temperature between 300° C. and 1100° C., preferably between 300° C. and 900° C. under argon or any other hydrogen-free atmosphere.

According to a second process, it is possible to deposit a coating layer on the metallic substrate by bringing the latter into contact with a solution of sol-gel type, for example of a tetravalent titanium alkoxide, in an alcoholic or aqueous medium, the solution including an additional source of carbon such as an additional organic compound or carbon black, for example according to a process as described in patent application WO2018/115749A1. This additional compound enables the reduction and the formation of a TiOₓ oxide layer according to the invention, during a calcining heat treatment of the coating layer thus obtained, for example under an inert or reducing atmosphere.

According to another alternative process, the deposition of the coating layer may be carried out directly by impregnation starting from an aqueous suspension, or a suspension of any other solvent, of a TiOx powder or of a mixture of titanium oxide TiO₂ powder, preferentially in anatase form, supplemented by an additional source of carbon such as an additional organic compound or carbon black, as described in patent application WO2018/115749A1. According to this second embodiment, the TiOₓ layer according to the invention is obtained by the reduction of the initial TiO₂ layer during a subsequent heat treatment under the conditions described in application WO2018/115749A1.

The process may also consist of a deposition by thermal spraying, for example plasma spraying, of TiOx particles on the metallic support, in particular under the following conditions:

The powder used for the plasma spraying may be an electrically melted powder (i.e. a TiOx powder melted, then cooled and ground in particular according to patent application EP2900602), having a mean particle size between 10 and 100 micrometers, essentially containing the Ti₄O₇, Ti₅O₉, Ti₃O₅ and Ti₆O₁₁ phases. This powder is injected, by means of a carrier gas (for example argon at a flow rate of the order of 1 to 10 l/min) into a plasma generated by a plasma torch fed with plasma gases (for example a mixture of argon and hydrogen).

The substrate may be sandblasted beforehand for better adhesion.

According to another alternative process, it is possible to carry out the chemical oxidation of the titanium substrate in order to obtain a surface layer of TiO₂, which is then reduced to give a TiOₓ layer according to the invention.

According to other alternative processes, it is possible to produce the TiOₓ coating layer by atomic layer deposition, chemical vapor deposition or physical vapor deposition.

In order not to needlessly weigh down the present description, not all the possible combinations according to the invention between the various preferred embodiments of the compositions of the products according to the invention, such as have just been described above, are reported. It is, however, clearly understood that all the possible combinations of the initial and/or preferred values and fields previously described are envisioned at the time of filing of the present application and should be considered as described by the applicant in the context of the present description (in particular two, three or more combinations).

The invention and its advantages will be understood more clearly on reading the nonlimiting examples which follow.

### EXAMPLES

in these examples, the performance for degradation of paracetamol by two embodiments according to the invention was measured.

### Example 1 (Comparative)

A first membrane is obtained by a process comprising the plasma deposition of a TiOₓ powder on a water-impermeable titanium metal plate.

The powder used for the plasma spraying is an electrically melted powder (i.e. a TiOx powder melted, then cooled and ground), having a mean particle size of the order of 30 micrometers, essentially containing the Ti₄O₇, Ti₅O₉, Ti₃O₅ and Ti₆O₁₁ phases. This powder is injected, by means of an argon carrier gas with a flow rate of 4 l/min, into a plasma generated by a Saint-Gobain Pro-Plasma torch fed with plasma gases (mixture of Ar with a flow rate of 45 l/min and of H2 with a flow rate of 11 l/min) under a voltage of 63-66 V (current 600 A); an argon shield makes it possible to prevent the reoxidation of the TiOₓ particles during the spraying. The substrate is sandblasted beforehand with alumina-zirconia grains under a pressure of 5 bar. The spraying distance is 110 mm.

The characteristics of the membrane are the following: the substrate is a TA6V plate with a thickness of 2 mm. The TiOₓ layer is deposited on the 2 faces until a coating thickness of around 300 micrometers is obtained.

At the same time as the deposition on the plate according to the invention, another deposition was carried out under the same conditions, this time on a substrate consisting of a non-sandblasted pellet of a titanium alloy TA6V with a diameter of 15 mm. After the plasma deposition, the coating is recovered and analyzed by XRD so as to determine the phases constituting the TiOₓ coating. The XRD analysis gave the following results: predominant main phase: Ti₄O₇; minority secondary phases: rutile; Ti₃O₅; Ti₅O₉; Ti₈O₁₅.

### Example 2 (According to the Invention)

A second membrane is obtained by a process comprising the plasma deposition of a TiOₓ powder this time on a titanium metal screen.

The characteristics of the membrane are the following: The substrate is a titanium screen from the company ITALFIM, the dimensional characteristics of which are the following:

The titanium screen has holes in the shape of diamonds with a period along the long diagonal of 4 mm; and along the short diagonal of 2.2 mm, the width of the strand being 0.6 mm and its thickness 0.5 mm. Its overall porosity is measured as being of the order of 33% and the median diameter of its pores (its holes) is measured as substantially equal to 1.1 mm in the following way:

On an image obtained by a binocular microscope, image analysis processing is carried out using the ImageJ image processing software in order to estimate the surface area of the openings. From this data, the diameter of a disk of the same surface area and ultimately a median diameter of the openings are calculated. The result obtained was verified by measuring, on the same image, the length of each of the diagonals of the diamonds of the screen. The surface area of said diamonds and then the diameter of the disk of the same surface area are deduced therefrom.

The overall porosity of the screen was deduced from its length, width and thickness in order to determine a “geometric density” by dividing the calculated volume (length×width×thickness) by the mass of the screen. By dividing by the theoretical density of Ti, the porosity of the screen is obtained (in %). The calculation was verified by the Archimedes method.

The conditions of the plasma deposition are identical to those of example 1.

After plasma spraying on the 2 faces of the screen, the strand thickness is measured as substantially equal to 900 μm (micrometers) by observation with a binocular magnifier; the strand thickness being initially 600 μm, it is possible to estimate a deposition thickness substantially equal to 150 μm.

### Example 3 (According to the Invention)

A third membrane is obtained by a process comprising the plasma deposition of a TiOₓ powder according to the same conditions as described above, this time on a titanium metal foam. The foam originates from the company American Elements.

Its porosity is characterized by mercury porosimetry; the pore volume is 35% and the median pore size by volume is 88 micrometers. Its thickness is 2.5 mm.

A plasma deposition of TiOₓ is carried out on the 2 faces of the foam under the same conditions as described above.
The deposit thus obtained was observed on a previously polished surface. A thickness of the TiOₓ layer on the walls of the foam of around 30 micrometers is measured.
The performance for degradation of paracetamol is measured by providing the membranes described in examples 1 to 3 in a purification device comprising:

In a 500 ml glass beaker containing demineralized water, 3.55 mg of Na₂SO₄ from the company VWR, and 30 mg of paracetamol (98%) from the company Acros Organics are dissolved; a magnetic stirrer rotating at 400 rpm; a water bath making it possible to regulate the temperature of the beaker at 30° C.

Immersed in this beaker are the following:
an anode (consisting of the Ti plate coated with TiOₓ for example 1; the Ti screen coated with TiOₓ for example 2, the foam coated with TiOₓ for example 3). 33 cm² of the membrane are immersed in each case.
a platinum cathode from the company HANNA Instruments.
a KCl-saturated Ag/AgCl reference electrode from the company BioLogic.

A current of 165 mA is imposed by a Princeton Applied Research Model 273 potentiostat.

In order to measure the performance for degradation of the organic species, the reduction in chemical oxygen demand (COD), expressed in mg of oxygen per liter, is measured. It represents the total content of oxidizable substances in the water. This parameter corresponds to the amount of oxygen that it is necessary to provide in order to chemically oxidize these substances.

The COD is measured as follows: at regular intervals, 2 ml of the sample to be characterized are poured into a COD reagent tube from the company Hanna Instruments; the tube is brought to 150° C. and maintained for 2 h at 150° C., then stirred and cooled; the COD value is given by colorimetric assay by means of a photometer from the company Hanna Instruments; before each measurement, a “blank” standard, consisting of the solution salted by Na₂SO₄, but with no paracetamol, is characterized in the same way.

The percentage reduction in COD as a function of time is given in the following table for the plate (comparative example), for the screen (example 2) and for the foam (example 3):

TABLE 1

| | t = 0 | t = 4 h |
|---|---|---|
| Plate | 0% | 15% |
| (example 1) | | |
| Screen | 0% | 22% |
| (example 2) | | |
| Foam | 0% | 70% |
| (example 3) | | |

1. An electrochemical device for purifying a fluid by oxidation of organic compounds contained in said fluid comprising an electrochemical filtering membrane, said electrochemical filtering membrane comprising:
a metallic support said metallic support being permeable to said fluid,
a coating layer of said metallic support comprising or consisting of a titanium oxide of general formula TiOₓ, with x between 1.5 and 1.9.

2. The electrochemical device as claimed in claim 1, wherein the electrochemical filtering membrane is configured to act as electrode enabling the partial or complete degradation of said organic compounds.

3. The electrochemical device as claimed in claim 1, wherein the metallic support comprises or consists of a metal chosen from titanium, stainless steel.

4. The electrochemical device as claimed in claim 1, wherein the metallic support has a porosity of between 10% and 90%.

5. The electrochemical device as claimed in claim 1, wherein the metallic support has a median pore diameter, by volume, of between 10 micrometers and 10 millimeters.

6. The electrochemical device as claimed in claim 1, wherein the metallic support has a median pore diameter of less than 50 micrometers.

7. The electrochemical device as claimed in claim 1, wherein the metallic support has a median pore diameter of greater than 70 micrometers.

8. The electrochemical device as claimed in claim 25, wherein the metallic support is a screen.

9. The electrochemical device as claimed in claim 25, wherein the metallic support is a fabric of assembled metal wires.

10. The electrochemical device as claimed in claim 25, wherein the metallic support is a foam.

11. The electrochemical device as claimed in claim 10, wherein an overall open porosity of the foam is between 20% and 90%.

12. The electrochemical device as claimed in claim 10, wherein a median pore diameter of the foam, by volume, is between 2 micrometers and 10 millimeters.

13. The electrochemical device as claimed in claim 1, wherein the metallic support is in the form of a plate or a tube.

14. The electrochemical device as claimed in claim 1, wherein the material constituting the coating layer comprises more than 90% by weight, in total, of Magnéli phases selected from Ti₄O₇, Ti₅O₉, Ti₆O₁₁ or a mixture of at least two of these phases.

15. The electrochemical device as claimed in claim 1, further comprising means for introducing the fluid to be purified, means for circulating the fluid, for a possible pressurization thereof, means for powering the metallic support and means for recovering the purified fluid.

16. An electrochemical filtering membrane for the purification of a fluid, comprising:
a metallic support, said metallic support being permeable to said fluid,
a coating layer of said metallic support comprising or consisting of a titanium oxide of general formula TiOₓ, with x between 1.5 and 1.9.

17. A process for manufacturing an electrochemical filtering membrane as claimed in claim 16, wherein the metallic support comprises or consists of titanium, and wherein the method comprises manufacturing the coating layer by oxidation by anodization or chemical treatment of the metallic support in order to obtain a layer comprising TiO₂ then reduction of said Ti O₂ to give a titanium oxide of general formula TiOx, with x between 1.5 and 1.9.

18. A process for manufacturing an electrochemical filtering membrane as claimed in claim 16, comprising performing a first step according to which the metallic support is bought into contact with a solution of sol-gel type comprising titanium, said solution optionally including an additional source of carbon, then performing a second step of heat treatment of the sol-gel layer in order to obtain a coating layer of TiOx, at a temperature between 500° C. but not exceeding 1430° C. at atmospheric pressure, under an inert or reducing atmosphere.

19. A process for manufacturing an electrochemical filtering membrane as claimed in claim 16, comprising depositing the coating layer on the metallic support by impregnation starting from an aqueous suspension, or a suspension of another solvent, of a TiOx powder, followed by performing a heat treatment at a temperature between 500° C. but not exceeding 1430° C. at atmospheric pressure, under an inert or reducing atmosphere.

20. A process for manufacturing an electrochemical filtering membrane as claimed in claim 16, comprising depositing the coating layer on the metallic support by impregnation starting from an aqueous suspension, or a suspension of another solvent, of a mixture of titanium oxide TiO₂ powder, supplemented by an additional source of carbon, the coating layer of TiOx being obtained by reduction of said TiO₂ layer by a subsequent heat treatment at a temperature between 800° C. but not exceeding 1430° C. at atmospheric pressure, under an inert or reducing atmosphere.

21. A process for manufacturing an electrochemical filtering membrane as claimed in claim 16, comprising depositing the coating layer on the metallic support by thermal spraying of TiOx particles on said metallic support.

22. A method comprising oxidizing a fluid comprising organic compounds with the electrochemical device as claimed in claim 1.

23. The method as claimed in claim 22, wherein the metallic support is a metallic foam, comprising or consisting of a metal chosen from titanium, stainless steel.

24. A process for purifying a fluid, said fluid comprising organic compounds, said process comprising introducing said fluid into the electrochemical device as claimed in claim 1, bringing said fluid into contact with said electrochemical filtering membrane acting as electrode, under conditions for oxidation of said organic compounds, and drawing off the fluid thus decontaminated.

25. The electrochemical device as claimed in claim 1, wherein the metallic support is a screen, a fabric, an open-pore foam or a honeycomb.

26. The electrochemical device as claimed in claim 2, wherein the electrochemical filtering membrane is configured to act as an anode, enabling the partial or complete degradation of said organic compounds.
